(19) United States
(12) Patent Application Publication
(10) Pub. No.: US 2019/0044296 A1
(43) Pub. Date: Feb. 7, 2019

(54) WIRE WATERPROOFING METHOD AND WIRE WATERPROOFING STRUCTURE

(71) Applicant: YAZAKI CORPORATION, Tokyo (JP)

(72) Inventor: Yasunori NABETA, Shizuoka (JP)

(73) Assignee: YAZAKI CORPORATION, Tokyo (JP)

(21) Appl. No.: 16/049,968

(22) Filed: Jul. 31, 2018

(30) Foreign Application Priority Data
Aug. 2, 2017 (JP) 2017-149828

(51) Int. Cl. H01R 43/00; H01R 4/02; H01R 4/22; H01R 4/72; H01R 43/02

(52) U.S. Cl. CPC H01R 43/005; H01R 4/029; H01R 43/0207; H01R 4/22; H01R 4/72; H01R 4/021

(57) ABSTRACT

A wire waterproofing method includes the successive steps of: removing a sheath at a part of each of a plurality of wires; gathering the wires having conductors exposed due to the removal of the sheaths and molding a part of the sheath of each of the wires so as to eliminate a gap among the plurality of wires; bonding the exposed conductors of the wires to each other after the molding of the sheaths of the wires; and sealing the molded sheaths and the exposed conductors after the bonding of the exposed conductors.

### CROSS REFERENCE TO RELATED APPLICATION

This application is based upon and claims the benefit of priority from the prior Japanese Patent Application No. 2017-149828 (filing date: Aug. 2, 2017), the entire contents of which are incorporated herein by reference.

### BACKGROUND

### Technical Field

The present invention relates to a wire waterproofing method and a wire waterproofing structure, and particularly to a method of bonding sheaths of a plurality of wires to each other and conductors of the wires to each other.

### Related Art

Conventionally, a waterproofing structure 307 of a wire terminal in which sheaths 303 are removed at ends of a plurality of wires 301 to expose conductors 305 and these exposed conductors 305 are ultrasonically bonded to each other as illustrated in FIGS. 19 to 21 is known (see JP 2013-17286 A).

In this wire terminal waterproofing structure 307, a splice (a junction of the conductors 305) 315 is inserted into a cap 313 configured by tightly fitting a stopper 311 to an opening at one end of a heat-shrinkable tube 309.

Further, a water-stopping member 319 is pressure-injected into the cap 313 from a water-stopping member injection hole 317 provided in the stopper 311 after shrinkage of the heat-shrinkable tube 309, thereby waterproofing the splice 315 and the like.

### SUMMARY

Meanwhile, since the water-stopping member 319 is injected from the water-stopping member injection hole 317 into the cap 313 after the shrinkage of the heat-shrinkable tube 309 in the conventional wire terminal waterproofing structure 307, there is a problem that the water-stopping member 319 does not completely reach a portion (gap) 321 (see FIG. 21) among the wires 301 so that the sealing (waterproofing) becomes incomplete.

The invention has been made in view of the above problem, and an object thereof is to provide a wire waterproofing method and a wire waterproofing structure in which conductors of a plurality of wires are bonded to each other and such a bonded portion is waterproofed, the method and structure capable of solving the incompletion in waterproofing of the bonded portion.

A wire waterproofing method according to a first aspect of the invention includes the successive steps of: removing a sheath at a part of each of a plurality of wires; gathering the wires having conductors exposed due to the removal of the sheaths and molding a part of the sheath of each of the wires so as to eliminate a gap among the plurality of wires; bonding the exposed conductors of the wires to each other after the molding of the sheaths of the wires; and sealing the molded sheaths and the exposed conductors after the bonding of the exposed conductors.

A wire waterproofing method according to a second aspect of the invention includes: removing a sheath at a part of each of a plurality of wires; gathering the wires and molding a part of the sheath of each of the plurality of wires so as to eliminate a gap among the plurality of wires; bonding exposed conductors of the plurality of wires to each other, and sealing the molded sheaths and the exposed conductors. In this wire waterproofing method, these steps are executed in the order of the removal of the sheath, the gathering of the plurality of wires and molding of the sheath, the bonding of the exposed conductors, and the sealing of the molded sheath and the exposed conductors, these steps are executed in the order of the removal of the sheath, the bonding of the exposed conductors, the gathering of the plurality of wires and molding of the sheath, and the sealing of the molded sheath and the exposed conductors, or these steps are executed in the order of the gathering of the plurality of wires and molding of the sheath, the removal of the sheath, the bonding of the exposed conductors, and the sealing of the molded sheath and the exposed conductors.

A wire waterproofing method according to a third aspect of the invention includes the successive steps of: removing a sheath at a part of each of a plurality of wires; molding a part of the sheath of each of the plurality of wires into a shape capable of tessellation for each of the plurality of wires having conductors exposed due to the removal of the sheaths; gathering the plurality of wires after performing the molding of the sheath and bonding the exposed conductors of the plurality of wires to each other; and integrating portions of the sheaths of the plurality of wires formed in a tessellation and sealing the portions of the sheaths of the plurality of wires formed in the tessellation and the exposed conductors in a state where the portions of the sheaths molded are formed in the tessellation after the bonding of the exposed conductors.

A wire waterproofing method according to a fourth aspect of the invention includes: removing a sheath at a part of each of a plurality of wires; molding a part of the sheath of each of the into a shape capable of tessellation for each of the plurality of wires; gathering the plurality of wires after performing the removal of the sheath and the molding of the sheath and bonding exposed conductors of the plurality of wires to each other; and integrating portions of the sheaths of the plurality of wires formed in a tessellation and sealing the portions of the sheaths of the plurality of wires formed in the tessellation and the exposed conductors in a state where the portions of the sheaths molded are formed in the tessellation after the bonding of the exposed conductors. In this wire waterproofing method, these steps are executed in the order of the removal of the sheath, the molding of the sheath, the gathering of the plurality of wires and bonding of the exposed conductors and the integration of the sheath and the sealing of the sheath and the exposed conductors, or these steps are executed in the order of the molding of the sheath, the removal of the sheath, the gathering of the plurality of wires and bonding of the exposed conductors, and the integration of the sheath and the sealing of the sheath and the exposed conductors.

A wire waterproofing structure according to a fifth aspect of the invention includes: a plurality of wires with partially-exposed conductors, the plurality of wires in which the exposed conductors are bonded to each other, and a part of a sheath of each of the plurality of wires is molded in a form in which there is no gap among the plurality of wires; and a sealing member that covers and seals a molded portion of the sheath of each of the plurality of wires and the exposed conductors.

A wire waterproofing structure according to a sixth aspect of the invention includes: a plurality of wires with partially-exposed conductors, the plurality of wires in which the exposed conductors are bonded to each other, a part of the sheath of the wire is molded in a shape capable of tessellation for each of the plurality of wires, and portions of the sheaths molded to be capable of tessellation are gathered to form a tessellation; and a sealing member that integrates the portions of the sheaths of the plurality of wires formed in the tessellation and covers and seals the portions of the sheaths of the plurality of wires formed in the tessellation and the exposed conductors.

The aspects according to the invention solve the incompletion in waterproofing of the bonded portion in the wire waterproofing method and the wire waterproofing structure in which the conductors of the plurality of wires are bonded to each other and the bonded portion is waterproofed.

### BRIEF DESCRIPTION OF DRAWINGS

FIG. 1A is a view illustrating a preparation-completed state of a sheath molding process in a wire waterproofing method according to a first embodiment of the invention, and is a view illustrating a cross section taken along a line IA-IA in FIG. 1B;

FIG. 1B is a view illustrating the preparation-completed state of the sheath molding process in the wire waterproofing method according to the first embodiment of the invention;

FIG. 2A is a view illustrating a state during molding in the sheath molding process in the wire waterproofing method according to the first embodiment of the invention, and is a view illustrating a cross section taken along a line IIA-IIA in FIG. 2B;

FIG. 2B is a view illustrating the state during molding in the sheath molding process in the wire waterproofing method according to the first embodiment of the invention;

FIG. 3A is a view illustrating a finished state of the sheath molding process and a bonding process in the wire waterproofing method according to the first embodiment of the invention, and is a view illustrating a cross section taken along a line IIIA-IIIA in FIG. 3B;

FIG. 3B is a view illustrating a finished state of the sheath molding process and the bonding process in the wire waterproofing method according to the first embodiment of the invention;

FIG. 4A is a view illustrating a preparation-completed state of a sealing process in the wire waterproofing method according to the first embodiment of the invention, and is a view illustrating a cross section taken along a line IVA-IVA in FIG. 4B;

FIG. 4B is a view illustrating the preparation-completed state of the sealing process in the wire waterproofing method according to the first embodiment of the invention;

FIG. 5A is a view illustrating a wire waterproofing structure according to the first embodiment of the invention, and is a view illustrating a cross section taken along a line VA-VA in FIG. 5B;

FIG. 5B is a view illustrating the wire waterproofing structure according to the first embodiment of the invention;

FIG. 6A is a view illustrating a preparation-completed state of a sheath molding process in a wire waterproofing method according to a second embodiment of the invention, and is a view illustrating a cross section taken along a line VIA-VIA in FIG. 6B;

FIG. 6B is a view illustrating the preparation-completed state of the sheath molding process in the wire waterproofing method according to the second embodiment of the invention;

FIG. 7A is a view illustrating a state during molding in the sheath molding process in the wire waterproofing method according to the second embodiment of the invention, and is a view illustrating a cross section taken along a line VIIA-VIIA in FIG. 7B;

FIG. 7B is a view illustrating the state during molding in the sheath molding process in the wire waterproofing method according to the second embodiment of the invention;

FIG. 8A is a view illustrating a finished state of the sheath molding process in the wire waterproofing method according to the second embodiment of the invention, and is a view illustrating a cross section taken along a line VIIIA-VIIIA in FIG. 8B;

FIG. 8B is a view illustrating the finished state of the sheath molding process in the wire waterproofing method according to the second embodiment of the invention;

FIG. 9A is a view illustrating a finished state of a bonding process in the wire waterproofing method according to the second embodiment of the invention, and is a view illustrating a cross section taken along a line IXA-IXA in FIG. 9B;

FIG. 9B is a view illustrating the finished state of the bonding process in the wire waterproofing method according to the second embodiment of the invention;

FIG. 10A is a view illustrating a preparation-completed state of a sealing process in the wire waterproofing method according to the second embodiment of the invention, and is a view illustrating a cross section taken along a line XA-XA in FIG. 10B;

FIG. 10B is a view illustrating the preparation-completed state of the sealing process in the wire waterproofing method according to the second embodiment of the invention;

FIG. 11A is a view illustrating a wire waterproofing structure according to the second embodiment of the invention, and is a view illustrating a cross section taken along a line XIA-XIA in FIG. 11B;

FIG. 11B is a view illustrating the wire waterproofing structure according to the second embodiment of the invention;

FIG. 12A is a cross-sectional view (the cross-sectional view taken along a plane orthogonal to a longitudinal direction of a wire) illustrating a modified example of the wire molded in the sheath molding process;

FIG. 12B is a cross-sectional view (the cross-sectional view taken along the plane orthogonal to the longitudinal direction of the wire) illustrating a modified example of the wire molded in the sheath molding process;

FIG. 12C is a cross-sectional view (the cross-sectional view taken along the plane orthogonal to the longitudinal direction of the wire) illustrating a modified example of the wire molded in the sheath molding process;

FIG. 13A is a view illustrating a preparation-completed state of a sealing process in a wire waterproofing method according to a third embodiment of the invention;

FIG. 13B is a view illustrating a cross section taken along a line XIIIB-XIIIB in FIG. 13A;

FIG. 14 is a perspective view illustrating a waterproof member to be used in the wire waterproofing method illustrated in FIGS. 13A and 13B;

FIG. 15A is a view illustrating a wire waterproofing structure according to the third embodiment of the invention;

FIG. 15B is a view illustrating a cross section taken along a line XVB-XVB in FIG. 15A;

FIG. 16A is a view illustrating the waterproof member illustrated in FIG. 14;

FIG. 16B is a view taken along an arrow XVIB in FIG. 16A;

FIG. 17A is a view illustrating a modified example of the waterproof member to be used in the wire waterproofing method illustrated in FIGS. 13A and 13B;

FIG. 17B is a view taken along an arrow XVIIB in FIG. 17A;

FIG. 18A is a view illustrating another modified example of the waterproof member to be used in the wire waterproofing method illustrated in FIGS. 13A and 13B;

FIG. 18B is a view taken along an arrow XVIIIB in FIG. 18A;

FIG. 19 is a view illustrating a conventional wire waterproofing structure;

FIG. 20 is a view illustrating the conventional wire waterproofing structure; and

FIG. 21 is a view illustrating the conventional wire waterproofing structure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

### First Embodiment

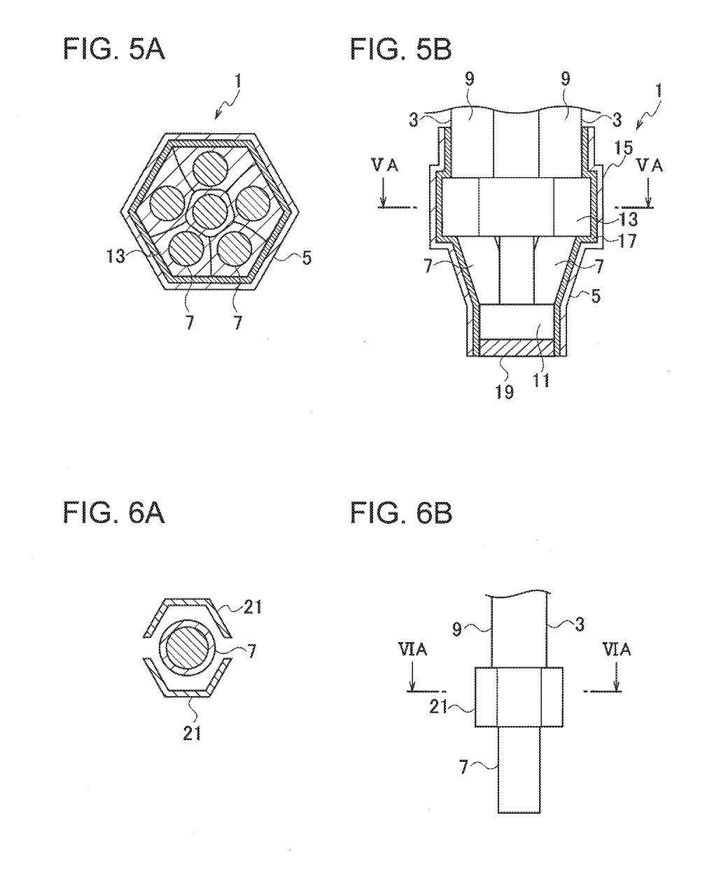

A wire waterproofing structure 1 according to a first embodiment of the invention is configured to include a plurality of wires 3 and a sealing member (cap) 5 as illustrated in FIGS. 5A, 5B, and the like.

A wire 3 is constituted by a conductor (core wire) 7 and a sheath (insulator) 9 with which the conductor 7 is covered (coated). The wire 3 has flexibility.

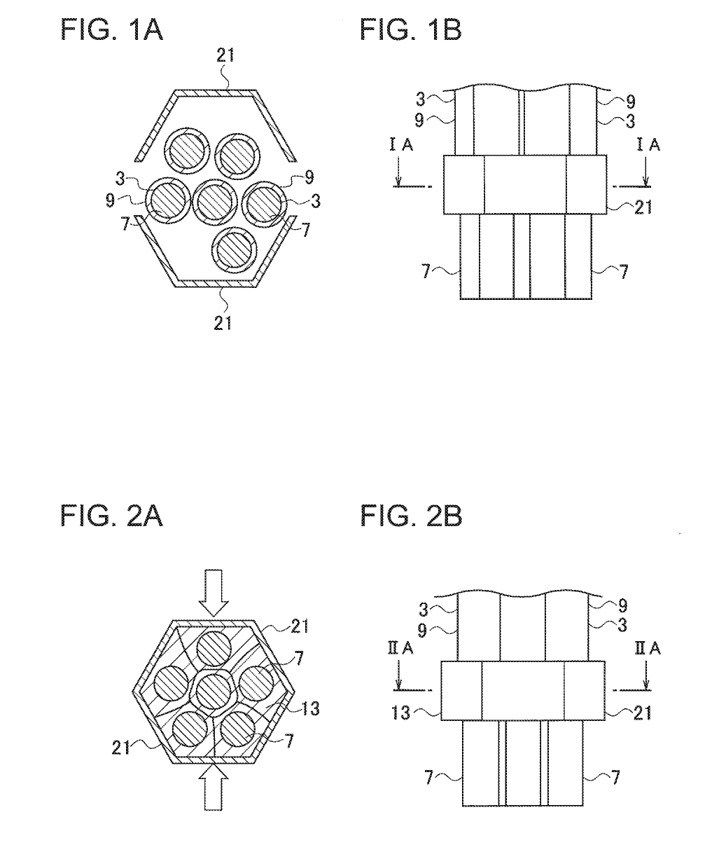

Specifically, a cross section of the wire 3 before a sheath-molded portion 13 to be described later is formed (the cross section taken along a plane orthogonal to a longitudinal direction) is formed in a predetermined shape such as a circular shape as illustrated in FIG. 1A and the like. The conductor 7 is constituted by, for example, a plurality of strands (not illustrated). The strand is formed in an elongated cylindrical shape with metal such as copper, aluminum, and an aluminum alloy.

The conductor 7 is configured in a form in which the plurality of strands are twisted or a form in which the plurality of strands collectively extend in a straight line. A cross section of the conductor 7 is formed in a substantially circular shape as the plurality of strands are bundled with almost no gap.

The sheath 9 is made of, for example, thermoplastic resin, and a cross section of the sheath 9 is formed in an annular shape having a predetermined width (thickness). The entire inner circumference of the sheath 9 is in contact with the entire outer circumference of the conductor 7. In addition, there is also a case where the conductor 7 is constituted by a single strand.

The sheath 9 is removed at a part, for example, one end in the longitudinal direction of the wire 3 over a predetermined length to expose the conductor 7.

In the plurality of wires 3, the exposed conductors 7 are bonded to each other, for example, by ultrasonic bonding or the like. In addition, a part of the sheath 9 of each of the wires 3 is molded to form a sheath-molded portion 13. In the sheath-molded portion 13, the sheath 9 is molded into a form in which a gap among the respective wires 3 is eliminated by, for example, pressure, heat, or ultrasonic waves such that the wires 3 are integrated (see FIG. 2A to 5B).

As illustrated in FIGS. 4A to 5B, the sealing member 5 is formed in a bottomed tubular shape, and covers and seals the portion 13 of the molded sheath 9 and the exposed conductor 7 (including a splice 11 which is a part where the conductors are ultrasonically bonded to each other) of each of the wires 3.

More specifically, positions of the respective wires 3 coincide with each other in the longitudinal direction of the wire 3 (up-down direction in FIG. 1B and the like). That is, positions of the exposed conductors 7 coincide with each other, and positions of portions of the wires 3 from which the sheaths 9 are not removed also coincide with each other. A portion 11 where the exposed conductors 7 are bond to each other is formed at distal ends of the exposed conductors 7. In addition, the sheath-molded portion 13 is formed near the exposed conductor 7.

More specifically, the sheath-molded portion 13 is formed from an end of the sheath 9, that is, the end positioned at a boundary between the sheath 9 and the exposed conductor 7 over a predetermined length in a direction away from the exposed conductor 7.

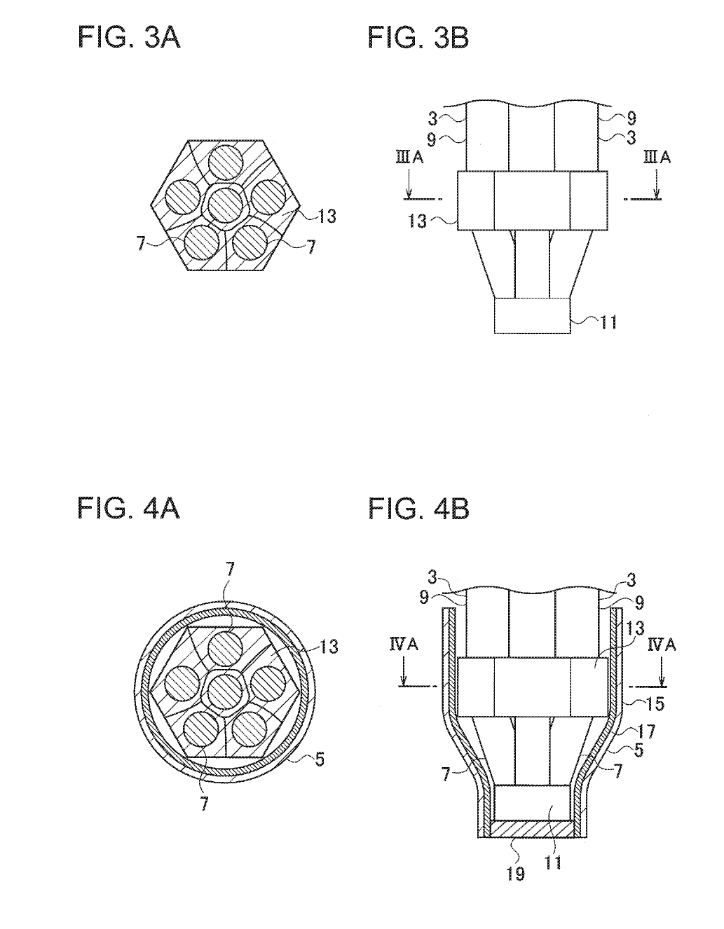

A cross section of the sheath-molded portion 13, specifically, the cross section taken along the plane orthogonal to the longitudinal direction of the wire 3, is formed in a shape of a regular hexagon or a shape close to the regular hexagon as illustrated in FIGS. 3A, 12A, and the like. Incidentally, the cross section of the sheath-molded portion 13 may be formed in a shape of a regular pentagon or a shape close to the regular pentagon or may be formed in a regular quadrangle or a shape close to the regular quadrangle as illustrated in FIGS. 12B and 12C, or may be formed in other polygonal shapes, such as polygonal shapes with all the interior angles smaller than 180°, or may be formed in a circular shape, an elliptical shape, or the like.

In addition, the sheath-molded portion 13 formed by the sheath 9 is filled with the material of the sheath 9 so that no gap is present in the sheath-molded portion 13 formed by the sheath 9 and water or the like does not pass through the sheath-molded portion 13 formed by the sheath 9.

Further, the conductors 7 are mutually shielded from each other by the molded sheath 9 in the sheath-molded portion 13, and all the conductors 7 are buried in the molded sheath 9 and do not appear on the surface (side surface) of the sheath 9.

Incidentally, outer diameters of the respective wires 3 are equal to each other in an aspect illustrated in FIGS. 1A to 5B, but the outer diameters of the respective wires 3 may be slightly different from each other. When the difference in the outer diameters of the wires 3 is large and it is difficult to perform molding to obtain the shape as illustrated in FIG. 3A or the like, the outer diameters of the wires 3 may be adjusted by winding a molding aid made of thermoplastic resin similar to the sheath 9 about the outer circumference of the sheath 9 before molding.

As described above, the sealing member 5 is formed in the bottomed tubular shape. Further, the sheath-molded portion 13 of each of the wires 3 and the exposed conductor 7 including the bonded portion 11 enter an inner portion of the sealing member 5, and the tubular portion of the sealing member 5 is in close contact with the sheath-molded portion 13 as illustrated in FIG. 5B.

More specifically, the sealing member 5 is configured to include a tubular heat-shrinkable tube 15, a water-stopping member (water stopping agent) 17 provided in a film shape on an inner surface of the heat-shrinkable tube 15, a stopper 19 that closes one opening of the heat-shrinkable tube 15 and the water-stopping member 17, for example, a stopcock that shrinks by heat as illustrated in FIG. 4B and the like.

Due to the heat shrinkage of the heat-shrinkable tube 15 and the like, an inner surface of the sealing member 5 is in contact with the sheath-molded portion 13 of each of the wires 3 and the exposed conductor 7 including the bonded portion 11, thereby sealing the sheath-molded portion 13 and the exposed conductor 7 as illustrated in FIG. 5B. That is, in the wire waterproofing structure 1 illustrated in FIG. 5B, water present at the unmolded sheath 9 or water present outside the sealing member 5 is blocked by the sheath-molded portion 13 and the sealing member 5, and does not enter the exposed conductor 7 inside the sealing member 5.

Meanwhile, the sealing member 5 is constituted by the heat-shrinkable tube 15, the water-stopping member 17, and the stopper 19 in the above description, but the heat-shrinkable tube 15 may be formed into a bottomed tubular shape to omit the stopper 19.

In this case, the water-stopping member 17 may be provided on the entire inner surface of the bottomed tubular-shaped heat-shrinkable tube, or the water-stopping member 17 may be provided only on a portion of the inner surface of the bottomed tubular-shaped heat-shrinkable tube that is in contact with the sheath-molded portion 13.

Next, a method of manufacturing the wire waterproofing structure 1, that is, a wire waterproofing method will be described.

First, the sheath 9 is removed over a predetermined length at a part of each of the plurality of wires 3 including the conductor 7 and the sheath 9 covering the conductor 7, for example, at one end in the longitudinal direction, thereby exposing the conductor 7 (a sheath removal process A).

Subsequently, the wires 3 with the conductors 7 exposed by removing the sheath 9 in the sheath removal process A are collected (see FIGS. 1A and 1B). Then, a part of the sheath 9 of each of the wires 3, particularly a part near the exposed conductor 7, is molded using a die 21 (a sheath molding process B; see FIGS. 2A and 2B) so as to eliminate the gap among the respective wires 3 and to bundle and integrate the respective wires 3. This molding is performed by applying heat, pressure, ultrasonic waves, or the like to the sheath 9, for example.

Subsequently, the exposed conductors 7 of the respective wires 3 are bonded to each other at least at a part thereof, for example, the distal ends of the conductors 7 as illustrated in FIGS. 3A and 3B after molding the sheath 9 of each of the wires 3 in the sheath molding process B (a bonding process C).

Subsequently, the molded sheath 9 (sheath-molded portion 13) and the exposed conductor 7 are sealed using the sealing member 5 after the bonding of the conductors 7 in the bonding process C (a sealing process D).

In the sealing process D, the heat-shrinkable sealing member 5 is placed to cover the sheath-molded portion 13 and the conductor 7 exposed on one side of the sheath-molded portion 13, and the heat-shrinkable sealing member 5 is heated and shrunk to seal the sheath-molded portion 13 and the exposed conductor 7 as illustrated in FIGS. 4A to 5B.

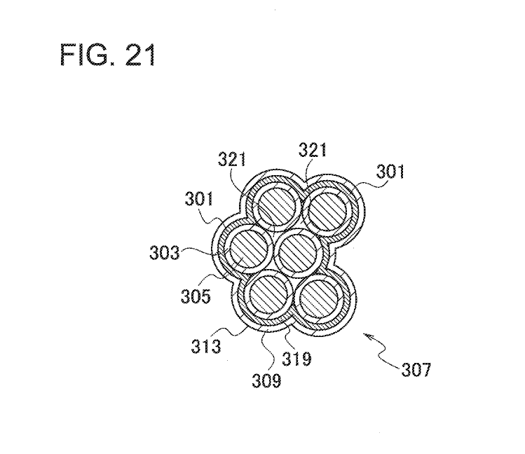

According to the wire waterproofing structure 1, the wires 3 with the exposed conductors 7 are collected, each part of the sheaths 9 of the wires 3 is molded so as to eliminate the gap among the wires 3, the exposed conductors 7 of the wires 3 are bonded to each other, and the molded sheath 9 (sheath-molded portion 13) and the exposed conductor 7 are sealed. As a result, it is possible to eliminate a gap 321 among wires illustrated in FIG. 21, and to prevent the incomplete sealing (waterproofing).

Meanwhile, although the processes are executed in the order of the sheath removal process A, the sheath molding process B, the bonding process C, and the sealing process D in the above-described method of manufacturing the wire waterproofing structure 1, the order of these processes may be changed as appropriate.

For example, these processes may be executed in the order of the sheath removal process A, the bonding process C, the sheath molding process B, and the sealing process D. In addition, these processes may be executed in the order of the sheath molding process B, the sheath removal process A, the bonding process C, and the sealing process D.

### Second Embodiment

A wire waterproofing structure 1a according to a second embodiment of the invention is different from the wire waterproofing structure 1 according to the first embodiment of the invention in that wires 3 are molded one by one and then the respective wires 3 are collected and sealed, and is configured in substantially the same manner as the wire waterproofing structure 1 in the other respects.

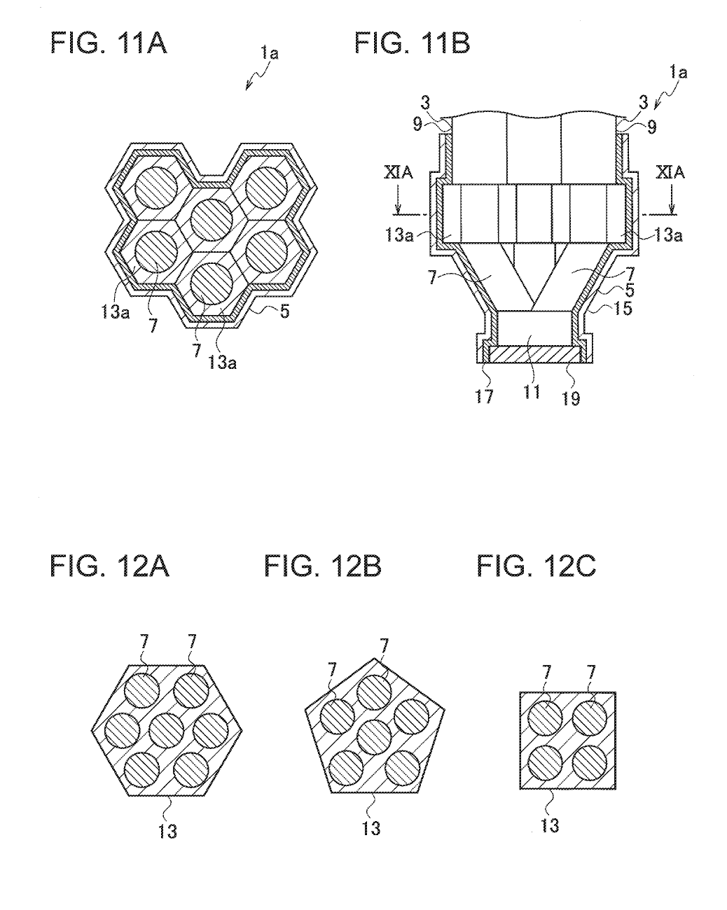

That is, the wire waterproofing structure 1a according to the second embodiment is configured to include the plurality of wires 3 and a sealing member 5 as illustrated in FIGS. 11A, 11B, and the like.

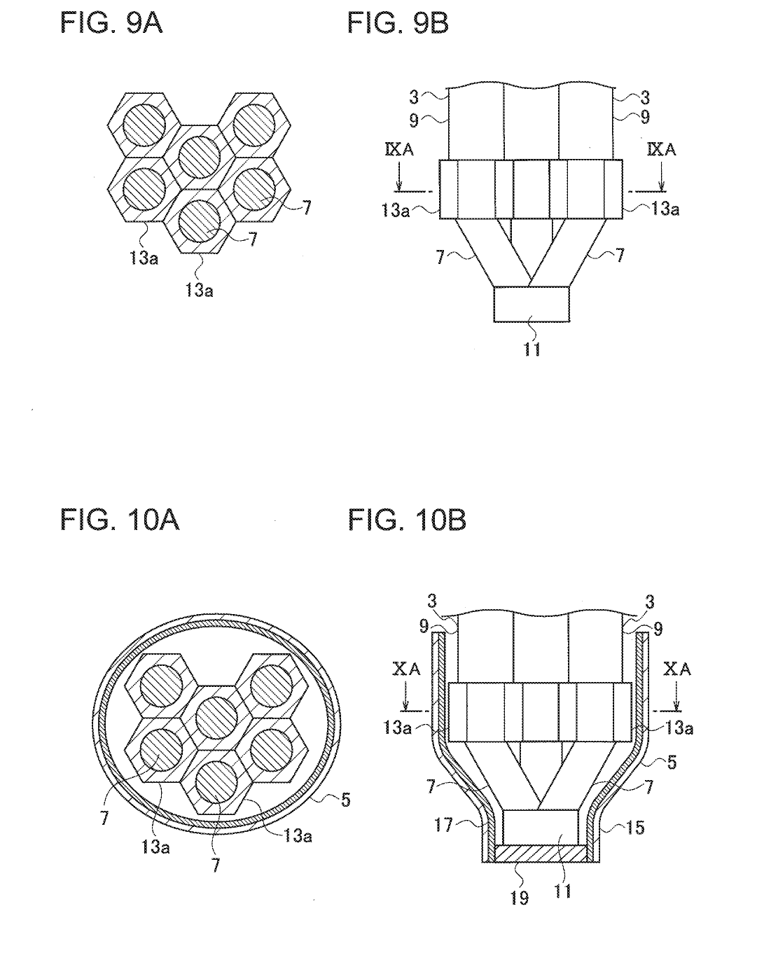

As illustrated in FIGS. 6A to 8B and the like, a sheath 9 is removed at a part, for example, one end in the longitudinal direction of the wire 3 over a predetermined length to expose a conductor 7. The exposed conductors 7 are bonded to each other as illustrated in FIGS. 9A, 9B, and the like.

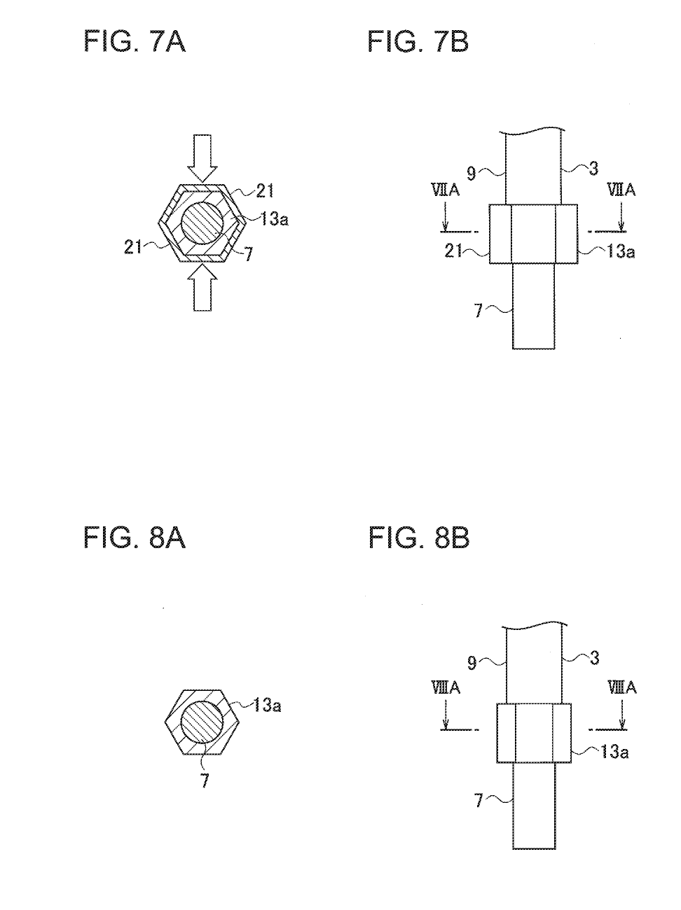

In addition, a part of the sheath 9 of the wire 3, that is, a portion near the exposed conductor 7 is molded for each of the wires 3 to form a sheath-molded portion 13a as illustrated in FIGS. 7A to 11B.

A cross section of the sheath-molded portion 13a taken along a plane orthogonal to the longitudinal direction of the wire 3 is formed in a shape capable of tessellation such as a regular hexagon shape, and these sheath-molded portions 13a that can be tessellated are gathered to form a tessellation (see FIGS. 9A, 10A and 11A).

Incidentally, the tessellation is an operation of laying finite kinds of planar figures inside a plane without any gap. The entire plane made up of the laid planar figures is called the tessellation. Incidentally, examples of a regular polygon that enables a plane to be filled with one kind thereof include a regular triangle, a regular tetragon, and a regular hexagon, and these polygons are called a regular tessellation.

There are various shapes capable of tessellation such as a rectangular shape and a parallelogram shape other than the regular polygon. In addition, there are shapes that enable a plane to be filled with a plurality of kinds thereof of course.

The sealing member 5 is configured in the same manner as the sealing member 5 of the wire waterproofing structure 1 according to the first embodiment. The sealing member 5 causes the portions (sheath-molded portions 13a) of the respective sheaths 9 of the wires 3 formed in the tessellation to be integrated and causes the sheath-molded portions 13a of the wires 3 formed in the tessellation and the exposed conductors 7 including the ultrasonically-bonded portion 11 to be positioned at the inner side to perform sealing.

Incidentally, each of the sheath-molded portions 13a is tightened by the sealing member 5, the respective sheath-molded portions 13a are brought into close contact with each other, and water or the like is shielded between the respective sheath-molded portions 13a and between the sealing member 5 and the sheath-molded portion 13a.

In addition, the sheath-molded portion 13a is positioned at the same location as the sheath-molded portion 13 of the wire waterproofing structure 1 according to the first embodiment in the longitudinal direction of the wire 3.

Cross-sectional shapes of the respective sheath-molded portions 13a are equal to each other. When outer diameters of the sheaths 9 before molding are different in the respective wires 3, the outer diameters of the wires 3 are adjusted using the molding aid as described in the first embodiment.

Next, a method of manufacturing the wire waterproofing structure 1a, that is, a wire waterproofing method will be described.

First, the sheath 9 is removed at a part of each of the plurality of wires 3 including the conductor 7 and the sheath 9 covering the conductor 7, for example, at one end in the longitudinal direction, thereby exposing the conductor 7 over a predetermined length (a sheath removal process E).

Subsequently, a portion close to the exposed conductor, which is a part of the sheath of the wire 3, is molded into the shape capable of tessellation, for each of the wires 3 having the conductors 7 exposed by removing the sheath 9 in the sheath removal process E (a sheath molding process F; see FIGS. 6A to 8B).

Subsequently, the respective wires 3 are gathered such that the plurality of sheath-molded portions 13a form a tessellation, and the exposed conductors 7 of the respective wires 3 are bonded to each other at least at a part thereof after performing the molding in the sheath molding process F (a bonding process G; see FIGS. 9A and 9B).

Subsequently, the sheath-molded portions 13a of the wires 3 formed in the tessellation are bundled and integrated, and the sheath-molded portion 13a of the wires 3 formed in the tessellation and the exposed conductors 7 are sealed in a state where the sheath-molded portions 13a form the tessellation after the bonding in the bonding process G (a sealing process H; see FIGS. 10A to 11B).

According to the wire waterproofing structure 1a, a part of the sheath 9 is formed into the shape capable of tessellation for each of the wires 3 having the exposed conductors 7, the respective wires 3 are gathered to bond the conductors 7 to each other, and the sheath-molded portion 13a of the wires 3 formed in the tessellation and the exposed conductors 7 are sealed after integrating the sheath-molded portion 13a formed in the tessellation in the state where the sheath-molded portions 13a thus molded form the tessellation.

As a result, it is possible to eliminate a gap 321 among wires illustrated in FIG. 21, and to prevent the incomplete sealing (waterproofing). In particular, even when the number of the wires 3 is large, it is easy to mold the sheaths 9 of the wires 3, and the incomplete sealing (waterproofing) is prevented.

In addition, since the sheath-molded portion 13a molded in the sheath molding process F has a regular hexagonal prism shape according to the wire waterproofing structure 1a, it is possible to obtain the shape capable of tessellation while minimizing a deformation amount of the sheath 9 in the sheath molding process F.

Meanwhile, although the processes are executed in the order of the sheath removal process E, the sheath molding process F, the bonding process G, and the sealing process H in the above-described method of manufacturing the wire waterproofing structure 1a, the order of these processes may be changed as appropriate.

For example, these processes may be executed in the order of the sheath molding process F, the sheath removal process E, the bonding process G, and the sealing process H.

When executing the sealing process H, a water-stopping member may be provided on an outer circumference of the molded portion 13a between the sheath-molded portions 13a of the respective wires 3.

In addition, the wires 3 are formed one by one in the above description.

However, a group of wires may be configured using a plurality of wires 3, this group of wires may be collectively molded, and a plurality of the groups of wires molded in this manner may be gathered to form a tessellation.

Incidentally, an outer diameter of the sheath-molded portions 13 or 13a is drawn to be larger than an outer diameter of the sheath 9 that is not subjected to molding in FIGS. 3B, 8B, and the like for convenience of description. However, the outer diameter of the sheath-molded portions 13 or 13a is substantially equal to the outer diameter of the sheath 9 that is not subjected to molding in practice since no additional material is added during the molding.

### Third Embodiment

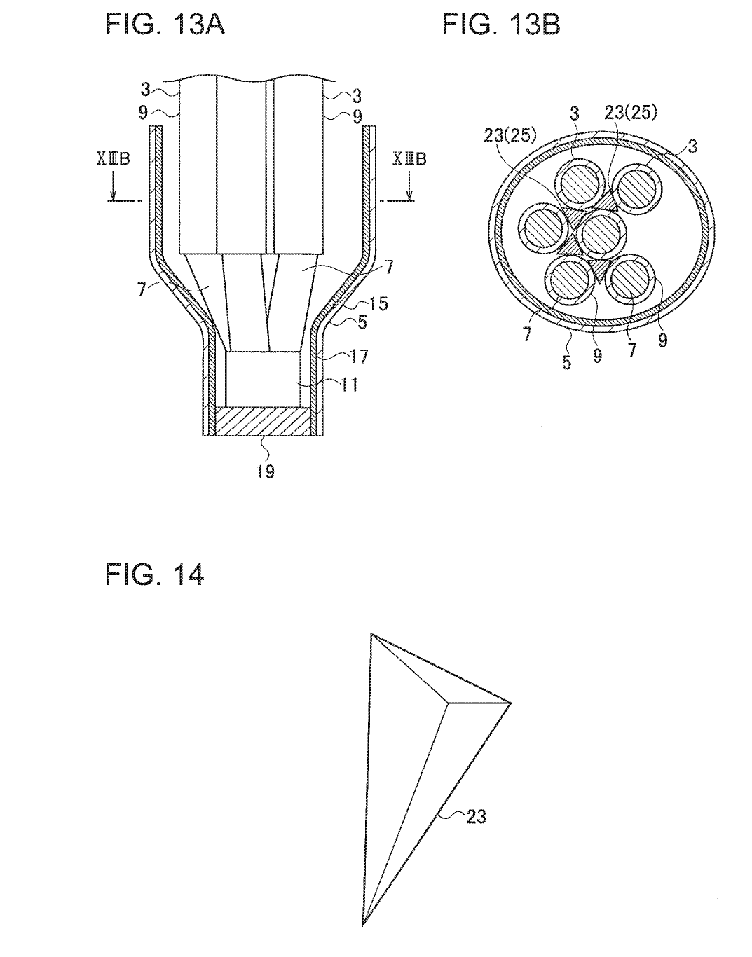

A wire waterproofing structure 1b according to a third embodiment of the invention is different from the wire waterproofing structure 1 according to the first embodiment of the invention in that a waterproof member 23 (see FIG. 14) having elasticity is arranged between wires 3 as illustrated in FIGS. 13A and 13B, and is configured in substantially the same manner as the wire waterproofing structure 1 in the other respects.

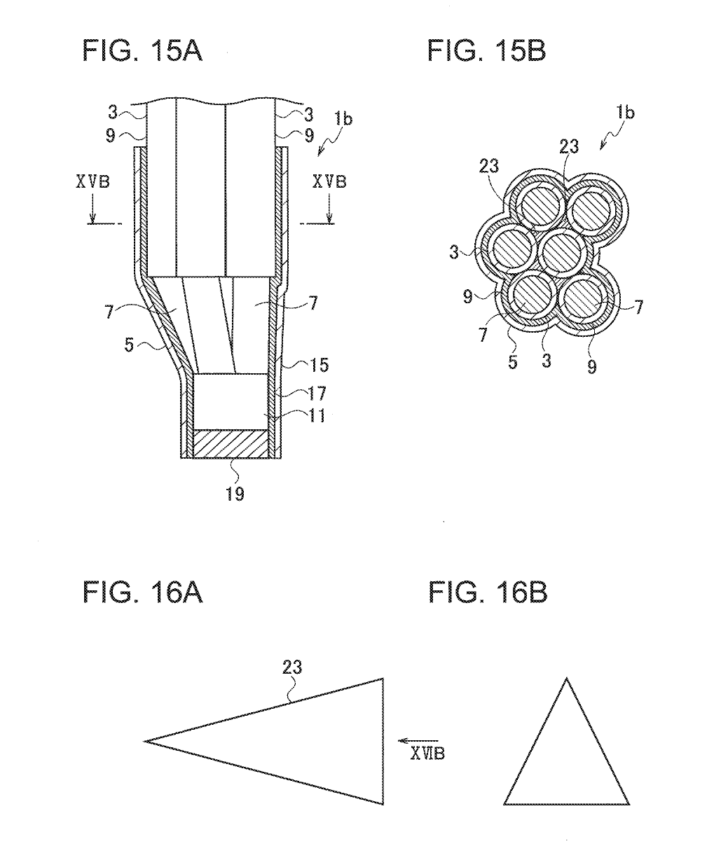

That is, in the wire waterproofing structure 1b according to the third embodiment, a triangular pyramid whose bottom surface is a regular triangle and triangles on three side surfaces are congruent with each other is installed in a gap (for example, a triangular gap) 25 formed between the respective wires 3 when gathering the wires 3, for example, as illustrated in FIGS. 16A and 16B. When gathering the wires 3, the gaps 25 formed among the wires 3 are buried and sealed using the sealing member 5 (see FIGS. 15A and 15B).

The waterproof member 23 is installed after bonding the conductors 7 of the wires 3 to each other and before providing the sealing member 5.

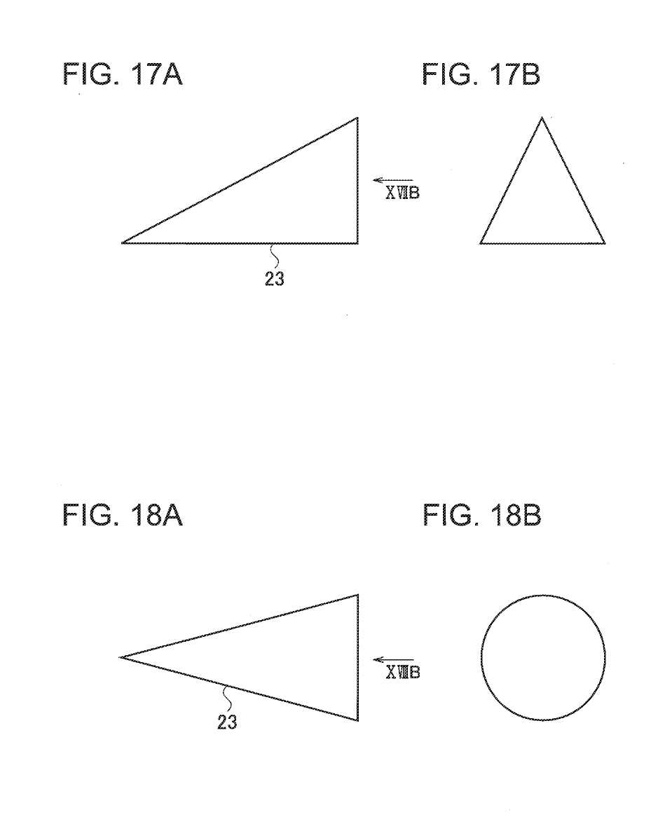

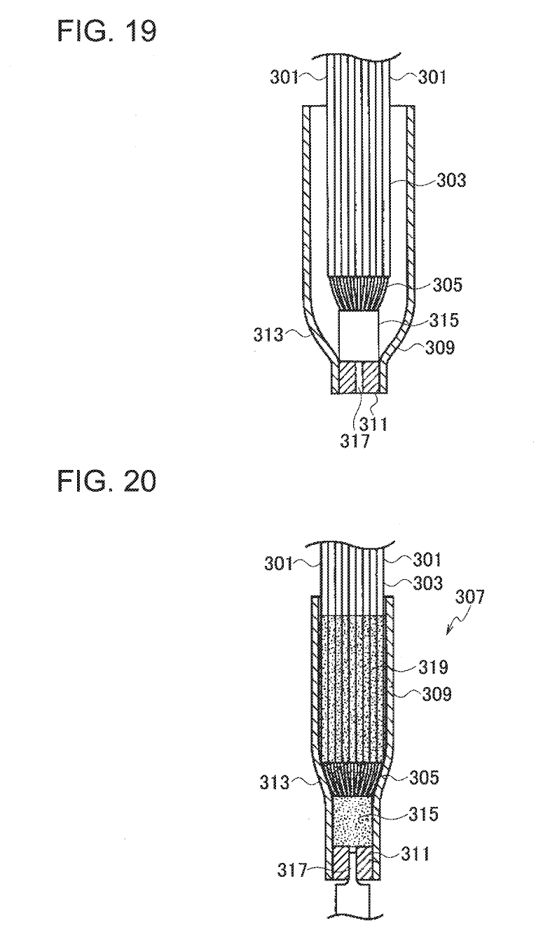

Incidentally, the waterproof member 23 is provided so as to be positioned on a side of the conductor 7 where an apex of the waterproof member 23 is exposed. In addition, as the waterproof member 23, a triangular pyramid shape having one side surface orthogonal to a bottom surface as illustrated in FIGS. 17A and 17B may be adopted, a conical shape as illustrated in FIGS. 18A and 18B may be adopted, or other shapes such as a truncated pyramid shape, a triangular prism shape, a truncated cone shape, and a columnar shape may be adopted.

In addition, a part of the sheath 9 and the waterproof member 23 may be molded as illustrated in FIGS. 2A, 2B, and the like after installing the waterproof member 23 and before providing the sealing member 5.

In the wire waterproofing structures 1, 1a, and 1b, a through-hole may be provided in the stopper 19 so as to inject a water-stopping member into the sealing member 5 through this through-hole.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A wire waterproofing method comprising the successive steps of:
removing a sheath at a part of each of a plurality of wires;
gathering the plurality of wires having conductors exposed due to the removal of the sheaths and molding a part of the sheath of each of the plurality of wires so as to eliminate a gap among the plurality of wires;
bonding exposed conductors of the plurality of wires to each other after the molding of the sheaths of the plurality of wires; and
sealing the molded sheaths and the exposed conductors after the bonding of the exposed conductors.

2. A wire waterproofing method comprising:
removing a sheath at a part of each of a plurality of wires;
gathering the plurality of wires and molding a part of the sheath of each of the plurality of wires so as to eliminate a gap among the plurality of wires;
bonding exposed conductors of the plurality of wires to each other; and
sealing the molded sheaths and the exposed conductors,
wherein the steps are executed in an order of the removal of the sheath, the gathering of the plurality of wires and molding of the sheath, the bonding of the exposed conductors, and the sealing of the molded sheath and the exposed conductors, the steps are executed in an order of the removal of the sheath, the bonding of the exposed conductors, the gathering of the plurality of wires and molding of the sheath, and the sealing of the molded sheath and the exposed conductors, or the steps are executed in an order of the gathering of the plurality of wires and molding of the sheath, the removal of the sheath, the bonding of the exposed conductors, and the sealing of the molded sheath and the exposed conductors.

3. A wire waterproofing method comprising the successive steps of:
removing a sheath at a part of each of a plurality of wires;
molding a part of the sheath of each of the plurality of wires into a shape capable of tessellation for each of the plurality of wires having conductors exposed due to the removal of the sheaths;
gathering the plurality of wires after performing the molding of the sheath and bonding the exposed conductors of the plurality of wires to each other; and
integrating portions of the sheaths of the plurality of wires formed in a tessellation and sealing the portions of the sheaths of the plurality of wires formed in the tessellation and the exposed conductors in a state where the portions of the sheaths molded are formed in the tessellation after the bonding of the exposed conductors.

4. A wire waterproofing method comprising:
removing a sheath at a part of each of a plurality of wires;
molding a part of the sheath into a shape capable of tessellation for each of the plurality of wires;
gathering the plurality of wires after performing the removal of the sheath and the molding of the sheath and bonding exposed conductors of the plurality of wires to each other; and
integrating portions of the sheaths of the plurality of wires formed in a tessellation and sealing the portions of the sheaths of the plurality of wires formed in the tessellation and the exposed conductors in a state where the portions of the sheaths molded are formed in the tessellation after the bonding of the exposed conductors,
wherein the steps are executed in an order of the removal of the sheath, the molding of the sheath, the gathering of the plurality of wires and bonding of the exposed conductors, and the integration of the sheath and the sealing of the sheath and the exposed conductors, or the steps are executed in an order of the molding of the sheath, the removal of the sheath, the gathering of the plurality of wires and bonding of the exposed conductors, and the integration of the sheath and the sealing of the sheath and the exposed conductors.

5. A wire waterproofing structure comprising:
a plurality of wires with partially-exposed conductors, the plurality of wires in which the exposed conductors are bonded to each other, and a part of a sheath of each of the plurality of wires is molded in a form in which there is no gap among the plurality of wires; and
a sealing member that covers and seals a molded portion of the sheath of each of the plurality of wires and the exposed conductors.

6. A wire waterproofing structure comprising:
a plurality of wires with partially-exposed conductors, the plurality of wires in which the exposed conductors are bonded to each other, a part of the sheath of the wire is molded in a shape capable of tessellation for each of the plurality of wires, and portions of the sheaths molded to be capable of tessellation are gathered to form a tessellation; and
a sealing member that integrates the portions of the sheaths of the plurality of wires formed in the tessellation and covers and seals the portions of the sheaths of the plurality of wires formed in the tessellation and the exposed conductors.
